(19) United States
(12) Patent Application Publication
(10) Pub. No.: US 2016/0217498 A1
(43) Pub. Date: Jul. 28, 2016

(54) Provision Of Identifier For Real-Time Bidding

(71) Applicant: Criteo SA, Paris (FR)

(72) Inventors: Alban de La Bretèche, Paris (FR); Eric Le Barz, Paris (FR); Patrick Wyatt, London (GB)

(21) Appl. No.: 14/605,881

(22) Filed: Jan. 26, 2015

(51) Int. Cl. G06Q 30/02; H04L 29/06

(52) U.S. Cl. CPC G06Q 30/0275; H04L 63/0428

(57) ABSTRACT

A webpage comprising first instructions to request ID data from a first ad decision system on a second domain, and second instructions to request an ad from a first real-time bidding platform on a third domain is received, by a computing device, from a webserver on a first domain. The first instructions are executed, by the computing device, to send a first request to the first ad decision system, the request including first data stored on the computing device and associated with the second domain. The ID data comprising an ID are received, by the computing device, from the first ad decision system. The second instructions are executed, by the computing device, to send a request to the first real-time bidding platform for the ad, the request comprising the ID. The ad is received, by the computing device, from the first real-time bidding platform.

### FIELD OF THE TECHNOLOGY

The present technology relates generally to real-time bidding for advertising opportunities and, more specifically, to providing information stored by bidders on a user device to the bidders during real-time auctions for advertising opportunities.

### BACKGROUND

Online and other electronic advertising allows advertisers to display advertisements (or ads) to users, including those who are potential customers. For example, a publisher webpage can include one or more opportunities for inserting advertisements from third-party advertisers (e.g., space for a banner advertisement across the top of the webpage, spaces for advertisements along the sides of the webpage, overlays, etc.). When a user device (e.g., a computer running a web browser) processes a publisher webpage for display, the user device can request an advertisement for one of the advertising opportunities on the webpage from a real-time bidding platform. The real-time bidding platform can request bids from bidders for the ability to provide an advertisement for the advertising opportunity on the user device. The real-time bidding platform can select a winning bidder and provide an ad or ad tag from the winning bidder to the user device for display within the area of the webpage associated with the advertising opportunity.

In some instances, a bidder may have stored information on the user device that can help the bidder determine whether and how much to bid for an advertising opportunity. For example a bidder may have stored on the user device information that identifies the user device to the bidder in a cookie associated with the bidder's domain. Standard web browsers (e.g. Chrome, Safari, Internet Explorer, or Firefox browsers) running on the user device do not allow reading the bidder's cookie by the publisher webpage because the bidder's cookie is not associated with the publisher's domain. In such instances, the user device cannot provide the bidder's information as a part of the request sent to the real-time bidding platform for an advertisement for one of the advertising opportunities on the publisher webpage.

### SUMMARY

Accordingly, there is need for technology to allow user devices to provide bidders' information (e.g., user ID) stored on the user devices to real-time bidding platforms where the user devices prevent accessing the bidder's information because it is associated with a third-party domain. The technology described herein beneficially provides methods for user devices to provide bidder information to a real-time bidding platform.

In one aspect there is a method performed by a computing device. The method includes receiving, by the computing device, from a webserver on a first domain, a webpage including first instructions to request ID data from a first ad decision system on a second domain, and second instructions to request an ad from a first real-time bidding platform on a third domain. The method includes executing, by the computing device, the first instructions to send a first request to the first ad decision system, the request including first data stored on the computing device and associated with the second domain. The method includes receiving, by the computing device, from the first ad decision system, the ID data including an ID. The method includes executing, by the computing device, the second instructions to send a request to the first real-time bidding platform for the ad, the request including the ID. The method includes receiving, by the computing device, from the first real-time bidding platform, the ad.

In some embodiments, the first data is a cookie associated with the second domain and stored on the computing device. In some embodiments, the ID data includes ID instructions and the method further includes executing, by the computing device, the ID instructions to store, on the computing device, the ID as associated with the second domain in a local cache on the computing device. In some embodiments, the ID is encrypted. In some embodiments, the ID is encrypted with an encryption key associated with the first real-time bidding platform. In some embodiments, the ID is an identifier associated with the computing device. In some embodiments, the ID is an identifier associated with a user of the computing device.

In another aspect there is a method. The method includes receiving, by a computing device, from a webserver on a first domain, a webpage including first instructions to request ID data from a first ad decision system on a second domain, and second instructions to request an ad from a first real-time bidding platform on a third domain. The method includes executing, by the computing device, the first instructions to send a first request to the first ad decision system, the request including first data stored on the computing device and associated with the second domain. The method includes, in response to the first request, determining, by the first ad decision system, an ID based on at least the first data. The method includes sending, by the first ad decision system, to the computing device, the ID data including the ID. The method includes executing, by the computing device, the second instructions to send a request to the first real-time bidding platform, the request including the ID. The method includes, in response to receiving the second request, sending, by the real-time bidding platform, to the first ad decision system, a first bid request including the ID. The method includes, in response to receiving the bid request, sending by the ad decision system, to the real-time bidding platform, a bid based on at least the ID.

In some embodiments, the first data is a cookie associated with the second domain and stored on the computing device. In some embodiments, the ID data includes ID instructions, and the method further includes executing, by the computing device, the ID instructions to store, on the computing device, the ID as associated with the second domain in a local cache on the computing device. In some embodiments, the ID is encrypted. In some embodiments, the ID is encrypted with an encryption key associated with the first real-time bidding platform. In some embodiments, the ID is an identifier associated with the computing device. In some embodiments, the ID is an identifier associated with a user of the computing device.

Other aspects and advantages of the present technology will become apparent from the following detailed description, taken in conjunction with the accompanying drawings, illustrating the principles of the technology by way of example only.

### BRIEF DESCRIPTION OF THE DRAWINGS

The foregoing and other objects, features, and advantages of the present technology, as well as the technology itself, will be more fully understood from the following description of various embodiments, when read together with the accompanying drawings, in which:

FIG. 1 is a diagram of a system in accordance with an embodiment of the technology.

FIGS. 2A and 2B illustrate a method for providing identifiers for real-time bidding on an advertisement opportunity.

### DETAILED DESCRIPTION

### Environment and Systems

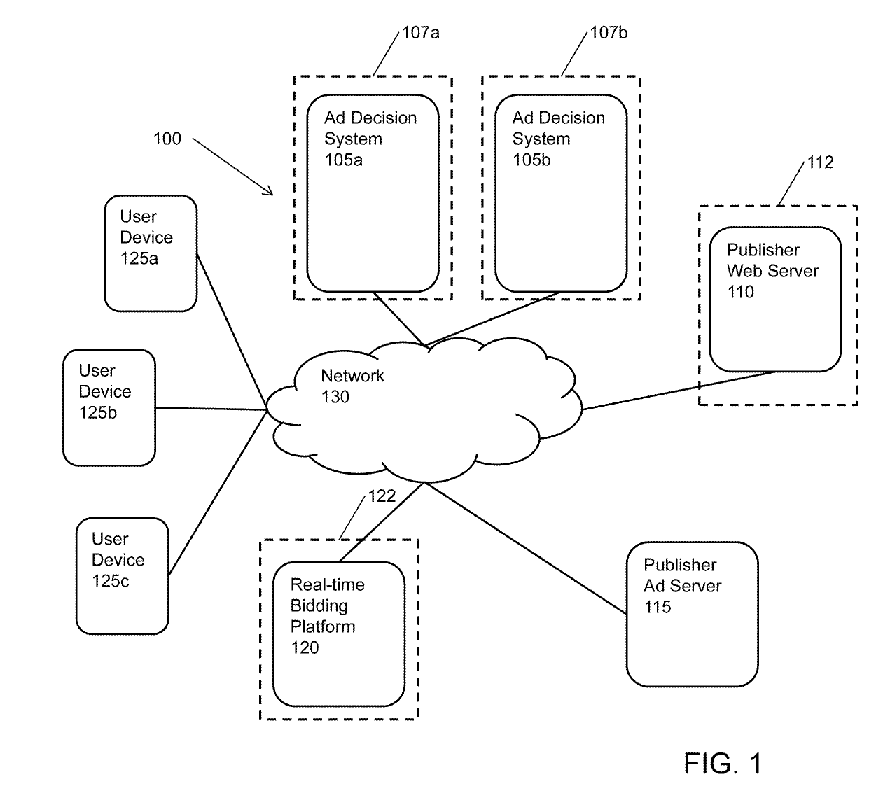

FIG. 1 is a diagram of system 100 in accordance with an embodiment of the technology. As illustrated, system 100 can include ad decision systems 105 on domains 107, publisher webserver 110 on domain 112, publisher ad server 115, real-time bidding platform 120 on domain 122, and user devices 125. In system 100, ad decision systems 105, publisher webserver 110, publisher ad server 115, real-time bidding platform 120, and user devices 125 can be in data communication with each other via network 130.

Ad decision systems 105 can be any computing system comprising one or more computing devices, such as servers. Ad decision system 105a can be on domain 107a (e.g., domain xyz.com). Generally, a domain can refer to a set of one or more network addresses. For example, multiple computing systems can be on a domain (e.g., xyz.com) and/or its subdomains (e.g., ads.xyz.com). In some instances, ad decision system 105a can collect information about user devices 125 (or the users of such devices), such as website browsing activity, online purchasing activity, and/or any other behavioral or demographic information. Ad decision system 105a can store cookies (e.g., HTTP cookies) on user devices 125 when communicating with user devices 125, such as during an HTTP request/response exchange. The cookies can include information that identifies user devices 125 (or the users of such devices) to ad decision system 105a allowing ad decision system 105a to correlate the information it has collected about user devices 125 with user devices 125. For example, the cookie can contain an ID that ad decision system 105a can use to access records of information about user devices 125 (or the users of such devices). Ad decision system 105b can be on domain 107b (e.g., domain tuv.com). Ad decision system 105b can similarly store cookies (e.g., HTTP cookies) on user devices 125 when communicating with user devices 125, such as during an HTTP request/response exchange.

Publisher webserver 110 can be any computing system comprising one or more computing devices, such as servers. Publisher webserver 110 can be on domain 112 (e.g., domain abc.com). In some embodiments, publisher webserver 110 can serve webpages (e.g., to user devices 125). Publisher ad server 115 can be any computing system comprising one or more computing devices, such as servers. Real-time bidding platform 120 can be any computing system comprising one or more computing devices, such as servers. Real-time bidding platform 120 can be on domain 122 (e.g., domain efg.com). In the illustrated example, domain 107a, domain 107b, and domain 112, and domain 122 can each be different domains. User devices 125 can be any computing system comprising one or more computing devices, such as personal computers or mobile computing devices. In some embodiments, user devices 125 can request webpages using browser software.

### Provision of Identifiers for Real-Time Bidding

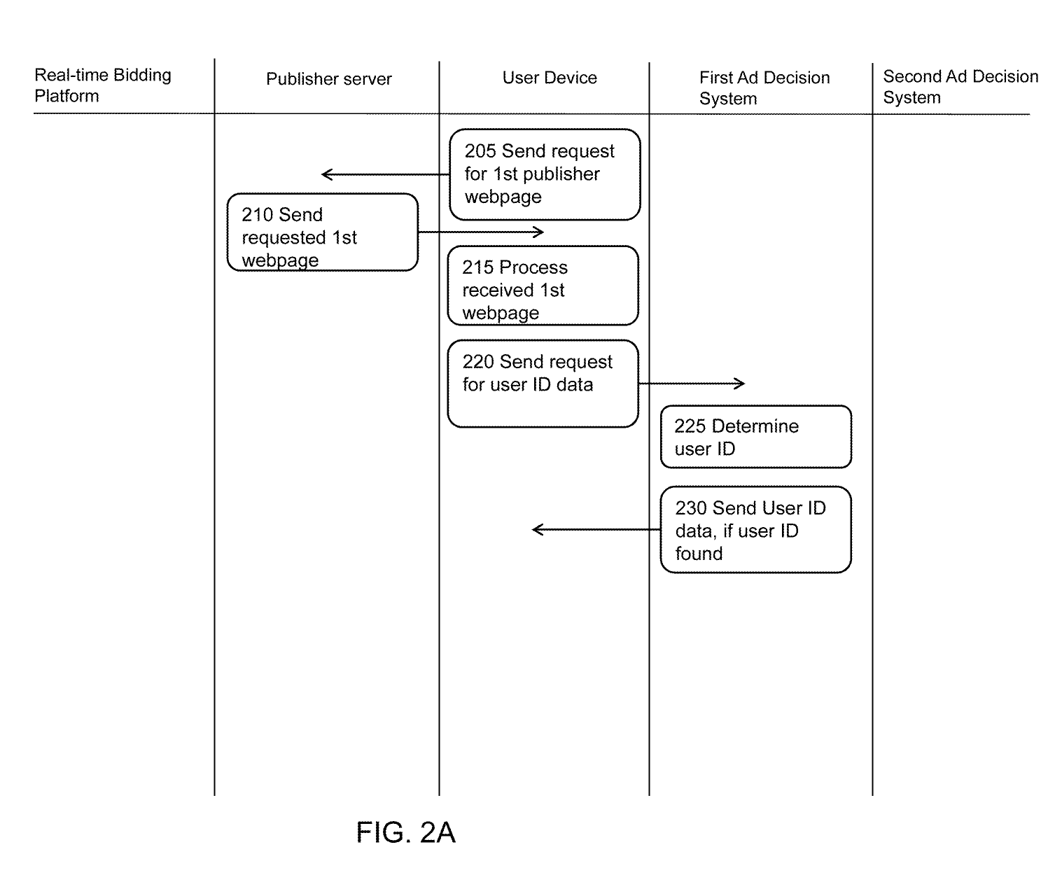

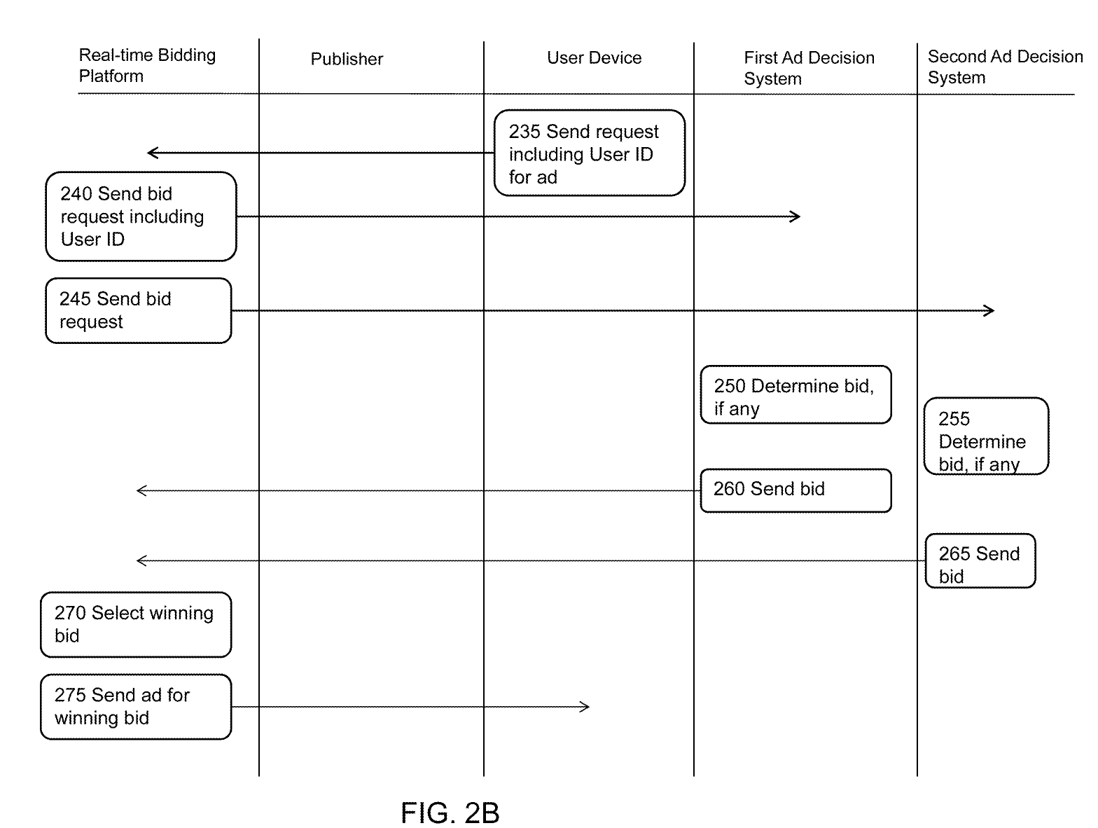

FIGS. 2A and 2B illustrate a method for providing identifiers for real-time bidding on an advertisement opportunity. In the illustrated method, processing by and communications between a real-time bidding platform (e.g., real-time bidding platform 120), a publisher server (e.g., publisher web server 110), a user device (e.g., user device 125a), a first ad decisions systems (e.g., ad decision system 105a), and a second ad decision system (e.g., ad decision system 105b) are shown. At step 205, the user device sends to the publisher server on a first domain (e.g., domain 112) a first request for a first publisher webpage. At step 210, the publisher server sends to the user device the first webpage. In accordance with the technology, the first publisher webpage can include first instructions to request ID data from the first ad decision system on a second domain (e.g., domain 107a). In some embodiments, the first instructions can be one or more script instructions (e.g., JavaScript instructions, or ActionScript instructions) to make a call to the first ad decision system to request ID data. For example, the first instructions can include instructions to call a URL of the form “http://xyz.com/userSync.aspx,” where “userSync.aspx” is a service provided by the first ad decision system on domain “xyz.com.” The first publisher webpage can include second instructions to request an ad from a first real-time bidding platform on a third domain (e.g., domain 122). The second instructions can include instructions to include a user ID in the request.

At step 215, the user device begins processing the first publisher webpage. Processing the first publisher webpage by the user device can include rendering the first publisher webpage and executing instructions contained in the first publisher webpage. The user device can execute the first instructions to send a second request to the first ad decision system. The second request can include first data stored on the user device that is associated with the second domain. For example, if the first instructions include instructions to call a URL on the first ad decision system of the form “http://xyz.com/userSync.aspx,” the call will cause the user device (or a browser running on the user device) to retrieve any cookies associated with domain “xyz.com” stored on the user device and send the contents of the cookies to the first ad decision system. At step 220, the user device sends the second request including the first data to the first ad decision system for user ID data. For example, the second request can include the name of the service on the first ad decision system (e.g., userSync.aspx) and the contents of any cookies associated with domain “xyz.com.”

At step 225, the first ad decision system determines a user ID associated with the user device. The first ad decision system can determine the user ID based on the first data contained in the second request received from the user device. In some embodiments, the first data (e.g., the contents of any cookies associated with domain “xyz.com.”) can contain the user ID. In some embodiments, the first ad decision system can determine the user ID from its stored records based on the first data.

At step 230, the first ad decision system sends, to the user device, ID data including the user ID, if a user ID is found. If no user ID is found, the first ad server can send indicia that no user ID was found, such as an empty string. In some embodiments, the ID data includes ID instructions. In some embodiments, the ID instructions can include script instructions for execution by the user device. For example, the ID instructions can include JavaScript instructions that, when executed by the user device, create a variable holding the user ID on the user device (e.g., in the context of a web browser on the user device). In some embodiments, the user ID can be stored in the cache of the user device. In some embodiments, the user ID can be encrypted by the first ad decision system. In some embodiments, the user ID can be encrypted by the first ad decision system with an encryption key associated with the real-time bidding platform. For example, the user ID can be encrypted with the real-time bidding platform's public key or a symmetric key assigned to the real-time bidding platform.

At step 235, the user device executes the second instructions to send a request to the real-time bidding platform for an ad to populate an advertising opportunity on the first publisher webpage. The request can include the user ID. Beneficially, the user device is able to send the user ID that was initially inaccessible in the cookie associated with the first ad decision system's domain.

At step 240, the real-time bidding platform sends a bid request to the first ad decision system. The bid request can include the user ID received from the user device. In some embodiments, at step 245, the real-time bidding platform can send a bid request to a second ad decision system, where the request does not include the user ID (e.g., because the user ID is proprietary to the first ad decision system). At steps 250 and 255 the ad decision systems can determine whether to supply bids for the advertising opportunity. In some embodiments, the first ad decision system can determine if and/or how much to bid based on the user ID. In some embodiments, if the user ID is an empty string, the first ad decision system will not bid. At steps 260 and 265, the first ad decision system and the second ad decision system can provide bids to the real-time bidding platform. At step 270, the real-time bidding platform can select a winning bid, and, at step 275, can send to the user device the ad or ad tag associated with the winning bid. The user device can retrieve (e.g., from publisher ad server 115 or a content distribution network) and display the ad in the advertising opportunity.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the technology by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The technology has been described in terms of particular embodiments. The alternatives described herein are examples for illustration only and not to limit the alternatives in any way. The steps of the technology can be performed in a different order and still achieve desirable results. Other embodiments are within the scope of the following claims.

What is claimed is:

1. A method performed by a computing device comprising:
receiving, by the computing device, from a webserver on a first domain, a webpage comprising first instructions to request ID data from a first ad decision system on a second domain, and second instructions to request an ad from a first real-time bidding platform on a third domain;
executing, by the computing device, the first instructions to send a first request to the first ad decision system, the request including first data stored on the computing device and associated with the second domain;
receiving, by the computing device, from the first ad decision system, the ID data comprising an ID;
executing, by the computing device, the second instructions to send a request to the first real-time bidding platform for the ad, the request comprising the ID; and
receiving, by the computing device, from the first real-time bidding platform, the ad.

2. The method of claim 1, wherein the first data is a cookie associated with the second domain and stored on the computing device.

3. The method of claim 1, wherein the ID data comprises ID instructions, the method further comprising:
executing, by the computing device, the ID instructions to store, on the computing device, the ID as associated with the second domain in a local cache on the computing device.

4. The method of claim 1, wherein the ID is encrypted.

5. The method of claim 4, wherein the ID is encrypted with an encryption key associated with the first real-time bidding platform.

6. The method of claim 1, wherein the ID is an identifier associated with the computing device.

7. The method of claim 1, wherein the ID is an identifier associated with a user of the computing device.

8. A method comprising:
receiving, by a computing device, from a webserver on a first domain, a webpage comprising first instructions to request ID data from a first ad decision system on a second domain, and second instructions to request an ad from a first real-time bidding platform on a third domain;
executing, by the computing device, the first instructions to send a first request to the first ad decision system, the request including first data stored on the computing device and associated with the second domain;
in response to the first request, determining, by the first ad decision system, an ID based on at least the first data;
sending, by the first ad decision system, to the computing device, the ID data comprising the ID;
executing, by the computing device, the second instructions to send a request to the first real-time bidding platform, the request comprising the ID;
in response to receiving the second request, sending, by the real-time bidding platform, to the first ad decision system, a first bid request comprising the ID; and
in response to receiving the bid request, sending by the ad decision system, to the real-time bidding platform, a bid based on at least the ID.

9. The method of claim 8, wherein the first data is a cookie associated with the second domain and stored on the computing device.

10. The method of claim 8, wherein the ID data comprises ID instructions, the method further comprising:
executing, by the computing device, the ID instructions to store, on the computing device, the ID as associated with the second domain in a local cache on the computing device.

11. The method of claim 8, wherein the ID is encrypted.

12. The method of claim 11, wherein the ID is encrypted with an encryption key associated with the first real-time bidding platform.

13. The method of claim 8, wherein the ID is an identifier associated with the computing device.

14. The method of claim 8, wherein the ID is an identifier associated with a user of the computing device.
